(19) United States
(12) Patent Application Publication
(10) Pub. No.: US 2010/0200790 A1
(43) Pub. Date: Aug. 12, 2010

(54) SOLENOID VALVE

(76) Inventor: Dietmar Kratzer, Tamm (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/665,611

(22) PCT Filed: Jun. 10, 2008
(86) PCT No.: PCT/EP2008/057189

§ 371 Date: Dec. 18, 2009

(30) Foreign Application Priority Data
Jun. 21, 2007 (DE) 10 2007 028 516.9

(51) Int. Cl. F16K 31/02

(52) U.S. Cl. 251/129.15

(57) ABSTRACT

The invention relates to a solenoid valve having a magnetic assembly and a valve cartridge including a valve insert, a closing element guided within the valve insert in a movable manner, and a valve body pressed into the valve insert. A main valve has a main sealing element connected to the closing element, and a main valve seat disposed in the valve body. A magnetic force generated by the magnetic assembly moves the closing element in the direction of the valve body, as a result of which the main sealing element is inserted into the main valve seat in a sealing manner. According to the invention, the valve body is configured as a sleeve, the open end of which is pressed into the valve insert. The main valve seat with a through opening on the inside is disposed at a hood-shaped end of the valve body sleeve. The valve body sleeve is configured in an elongated manner at the hood-shaped end by means of a tubular extension such that a seal with a valve assembly element, forming the valve base part, can be established via a sealing lip of the valve assembly element, with the lip resting against the exterior of the tubular extension in a sealing manner.

### PRIOR ART

The invention relates to a solenoid valve according to the preamble to the independent claim 1.

FIG. 1 shows a conventional solenoid valve, in particular for a hydraulic unit that is used, for example, in an antilock brake system (ABS), a traction control system (TCS), or an electronic stability program (ESP). As is clear from FIG. 1, the conventional solenoid valve 1, which is embodied for example in the form of a regulating valve that is open when it is without current, includes a magnet assembly 2 for producing a magnetic flux—which includes a housing cover 2.1, a winding support 2.2, a wire-wound coil 2.3, and a covering disk 2.4—and a valve cartridge 5—which includes a capsule 5.1, a valve insert 9 connected to the capsule via a seal weld, an armature 6 with a first closing element 7 embodied in the form of a plunger, and a return spring 8. The magnet assembly 2 produces a magnetic force that moves the longitudinally movable armature 6, together with the first closing element 7 embodied in the form of a plunger, toward the valve insert 9 in opposition to the force of the return spring 8. The wire-wound coil 2.3 that is wound onto the winding support 2.2 constitutes an electrical coil that can be triggered via electrical connections 2.5. The valve insert 9 conducts the magnetic flux—which has been introduced by the magnet assembly 2 via the covering disk 2.4—axially in the direction of the armature 6 via an air gap 3. The supply of current to the wire-wound coil 2.3 via the electrical connections 2.5 and the resulting magnetic flux cause the armature 6 to move toward the valve insert 9 in opposition to the force of the return spring 8.

In addition, the valve insert 9 receives the so-called valve body 10, which includes a main valve seat 10.1 into which the first closing element 7 embodied in the form of a plunger travels in a sealed fashion by means of a main sealing element 7.1 embodied as a spherical sealing cap in order to perform the sealing function of the solenoid valve 1. As is also clear from FIG. 1, the conventional solenoid valve 1 includes an eccentrically situated check valve 4 that performs a directionally oriented through-flow function. The essential parts of the check valve 4 of the conventional solenoid valve 1 include a movable sealing element, a check valve seat situated in a valve component 14, and a stroke limiter or support, in this case comprised of a flat filter, for limiting the maximum stroke of the movable sealing element. As a rule, the check valve 4 positioned eccentric to the main valve axis is embodied in the form of a ball/hollow cone design. The valve component 14 embodied in the form of a plastic insert comprises the valve bottom part and additionally serves to produce a seal in relation to a surrounding fluid block, to produce a seal in relation to the valve body 10, and to accommodate an annular filter and the flat filter.

A dome 13 of the valve component 14 is inserted into an internal bore 14.1 of the valve body 10 and produces a pressure-assisted seal there at a sealing location 12. The valve body 10 is press-fitted into the valve insert 9; the main sealing seat 10.1 is situated at the top of the valve body 10 and the press-fitting diameter in relation to the valve insert 9 is situated beneath it. In addition, the valve component 14 rests axially with a surface 11 against the valve insert 9.

FIG. 2 shows an alternative embodiment in which the valve body 10′ is embodied in the form of a sleeve and is press-fitted into the valve insert 9′. Analogous to the embodiment in FIG. 1, the valve body 10′ includes a main valve seat 10.1′ into which the first closing element 7′ embodied in the form of a plunger travels in a sealed fashion by means of a main sealing element 7.1′ embodied as a spherical sealing cap in order to perform the sealing function of the solenoid valve 1. As is also clear from FIG. 2, the valve component 14′ shown, which is embodied in the form of a plastic insert, includes an eccentrically situated check valve 4′ that performs a directionally oriented through-flow function. The valve component 14′ comprises the valve bottom part and additionally serves to produce a seal in relation to a surrounding fluid block, to produce a seal in relation to the valve body 10′, and to accommodate an annular filter and a flat filter. A dome 13′ of the valve component 14′ is likewise inserted into an internal bore 14.1′ of the valve body 10′ and produces a pressure-assisted seal there at a sealing location 12′. The valve body 10 is press-fitted into the valve insert 9′; the main sealing seat 10.1′ is situated at the top of the valve body 10 and the press-fitting diameter in relation to the valve insert 9′ is situated beneath it. In addition, the valve component 14′ rests axially with a surface 11′ against the valve insert 9′.

Since in the two conventional exemplary embodiments in FIGS. 1 and 2, the dome 13, 13′ of the valve component 14, 14′ protrudes into the valve body internal bore 14.1, 14.1′ to produce the seal, the dome 13, 13′ protrudes in the form of a relatively thin part from the quite solid volume of the valve assembly 14, 14′. In addition, the very small dimensions of the dome 13, 13′ make it quite delicate and therefore not very rugged from a strength standpoint. This is problematic in the sealing of the valve body 10, 10′ at the locations 12, 12′ and the sealing function requires a relatively high degree of complexity.

### DISCLOSURE OF THE INVENTION

The solenoid valve according to the invention, with the defining characteristics of the independent claim 1, has the advantage over the prior art that a valve body embodied in the form of a sleeve with an open end is press-fitted into a valve insert, with a main valve seat with a through opening being situated on the on the inside, at a cap-shaped end of the valve body sleeve. In addition, the valve body sleeve is embodied as elongated by a tubular extension at the cap-shaped end so that the seal can be produced with a valve component by means of a sealing lip that rests in a sealed fashion against the outside of the tubular extension. The new design of the seal between the valve component and the valve body advantageously permits a more rugged embodiment and a more reliable sealing function. The axial overlap of the valve body and valve component required for the sealing and insertion is achieved through the elongation of the valve body, which is preferably embodied as a rugged metal component, in particular a steel component. In addition, the valve component can be embodied in a more homogeneous fashion. The higher ruggedness advantageously results in a reduced securing complexity while the more homogeneous embodiment, particularly in plastic parts, results in simpler manufacturing processes with simple molds and also increases the ruggedness of the component.

Advantageous improvements of the solenoid valve disclosed in the independent claim 1 are possible by means of the measures and modifications disclosed in the dependent claims.

It is particularly advantageous that through a corresponding embodiment of a first annular groove situated in the valve component, the sealing lip is pressed against the tubular extension in a sealed, pressure-assisted fashion due to the pressure difference and/or the flow direction of the operating medium. The degree of pressure assistance can be adjusted, for example, by means of a length difference between a sealing region of the sealing lip against the tubular extension and a depth of a first annular groove situated in the valve component. By means of the length difference, it is possible to adjust the ratio of a surface that has a seal-reinforcing action to a surface that has a seal-releasing action.

In the design of the solenoid valve according to the invention, the sealing lip of the valve component can be elongated downward and, below the tubular extension, can have a constriction whose diameter can be predetermined in order to set a desired throttling action. This advantageously permits a simple variation of the embodiment in order to be able to provide the solenoid valve with different throttle sizes, depending on the system requirements.

The sealing lip of the valve component is deformed by the sealing action against the extension of the valve body. So that this deformation has no influence or only a reduced influence on the circularity of an eccentrically situated check valve seat, the check valve seat can be decoupled from the sealing lip through suitable decoupling means. For example, the decoupling can be provided through an intentional reduction of the rigidity of the valve component. The rigidity of the valve component can, for example, be reduced through the provision of at least one second annular groove extending in the circumferential direction. The at least one second annular groove extending in the circumferential direction can be stiffened in certain regions by means of radial ribs.

The drawings show advantageous embodiments of the invention described below as well as the conventional exemplary embodiments explained above for better comprehension. In the drawings, components and elements that perform the same or analogous functions are provided with the same reference numerals.

### BRIEF DESCRIPTION OF THE DRAWINGS

FIG. 1 is a schematic sectional depiction of a conventional solenoid valve.

FIG. 2 is a schematic sectional depiction of a lower region of a conventional solenoid valve.

FIG. 3 is a schematic sectional depiction of a first embodiment of a lower region of a solenoid valve according to the invention.

FIG. 4 is a schematic sectional depiction of a second embodiment of a lower region of a solenoid valve according to the invention.

### EMBODIMENTS OF THE INVENTION

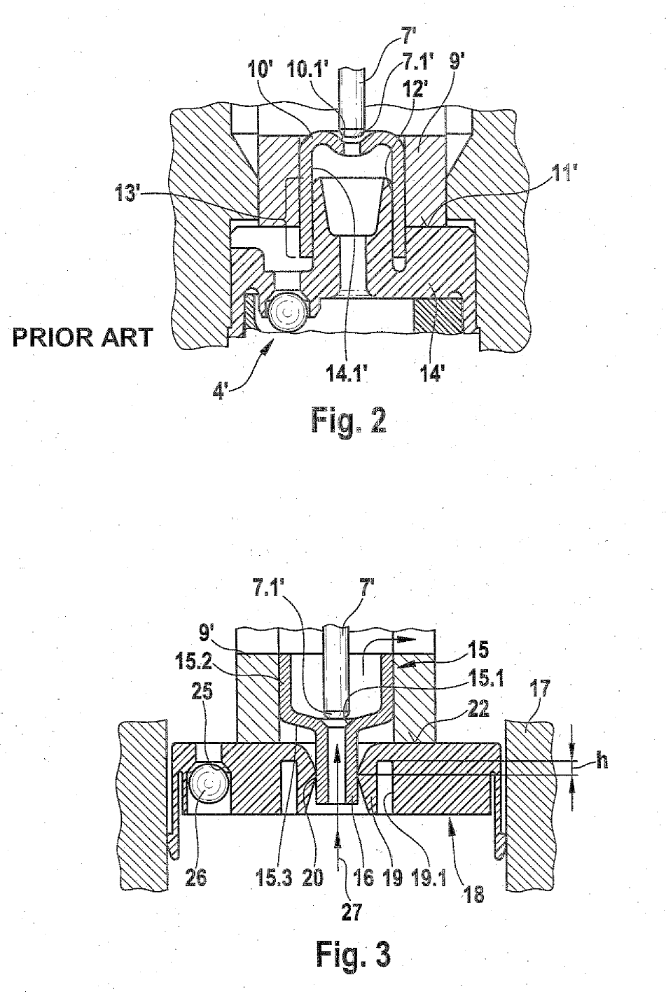

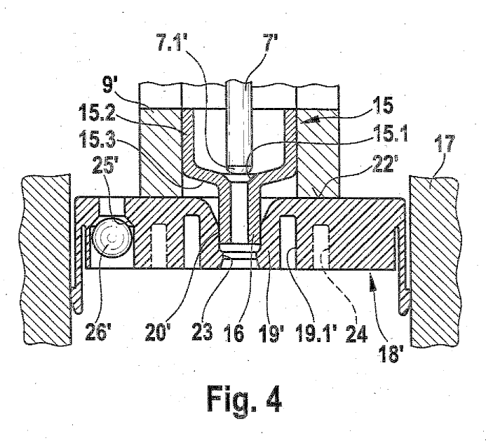

As is clear from FIGS. 3 and 4, the valve body 15 is embodied in the form of a sleeve that, by contrast with the prior art shown in FIG. 2, is press-fitted into a valve insert 9′ in a “reverse” orientation, i.e. an open end 15.2 of the valve body sleeve 15 situated at the top in the drawing is press-fitted into the valve insert 9′; a main valve seat 15.1 with a through opening is situated on the inside, at a cap-shaped end 15.3 of the valve body sleeve 15, which cap-shaped end 15.3 is situated at the bottom in the drawing. In addition, the valve body sleeve 15 at the cap-shaped end 15.3 is embodied as elongated by means of a tubular extension 16, thus producing an axial overlapping required for achieving the seal between the valve body sleeve 15 and a valve component 18, 18′ that comprises the valve bottom part. In order to produce the seal, a sealing lip 19, 19′ of the valve component 18, 18′ rests in a sealed fashion against a sealing region 20, 20′ on the outside of the tubular extension 16 of the valve body sleeve 15. In addition, the valve component 18, 18′ rests axially with a surface 22, 22′ against the valve insert 9′. The valve body sleeve 15 with the tubular extension is embodied as a metal part, preferably a steel part, and the valve component 18, 18′ is embodied as a plastic part.

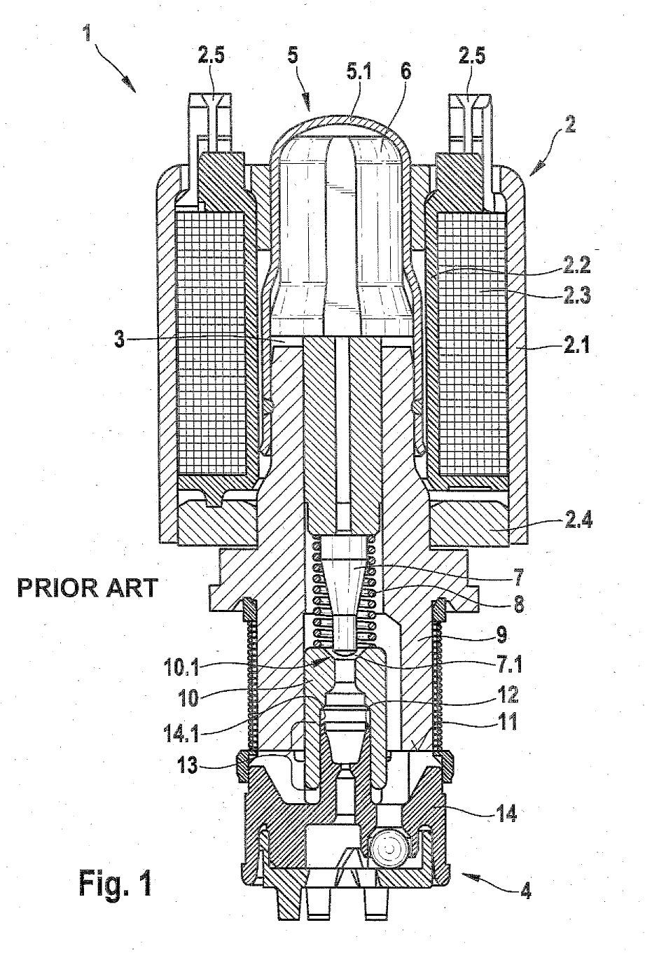

In each of the embodiments according to FIGS. 3 and 4, a magnetic force produced by a magnet assembly, not shown, moves the closing element 7′ in the direction of the valve body 15, causing the main sealing element 7.1′ to travel into the main valve seat 15.1 in a sealed fashion, making it possible to adjust a main fluid flow that presses from underneath against the main sealing element 7.1′, which is embodied for example as a spherical sealing cap. In an embodiment in the form of a solenoid valve that is open when it is without current, a return spring holds the main valve seat 15.1 open in the currentless state. The magnet assembly, not shown, which produces the magnetic force and the magnetic flux in order to move the closing element 7′ toward the valve body 15 when current is supplied, and the upper region of the solenoid valve according to the invention can be embodied in a fashion analogous to those in the solenoid valve 1 with the magnet assembly 2 shown in FIG. 1.

As is also clear from FIG. 3, through a corresponding embodiment of a first annular groove 19.1 situated in the valve component 18, in the sealing region 20, the sealing lip 19 is pressed in a sealed fashion against the tubular extension 16 in a pressure-assisted fashion due to the pressure difference and/or the flow direction of the operating medium, see directional arrows 27. The degree of pressure assistance can be adjusted by means of a length difference h between the sealing region 20 of the sealing lip 19 against the tubular extension 16 and a depth of the first annular groove 19.1 situated in the valve component 18. This means that the length difference h can be used to adjust the ratio of a surface of the sealing lip 19 that has a seal-reinforcing action to a surface of the sealing lip 19 that has a seal-releasing action, where h>0.

By contrast with the first embodiment according to FIG. 3, in the second embodiment according to FIG. 4, the sealing lip 19′ of the valve component 18′ is embodied as elongated downward and, below the tubular extension 16, has a constriction 23 whose diameter can be predetermined in order to set a desired throttling action. This advantageously permits a simple variation of the embodiment in order to be able to provide the solenoid valve with different throttle sizes, depending on the system requirements.

In all of the embodiments according to the invention, care must be taken to provide a flow-promoting design of the flow inlet. In addition, the sealing of the valve component 18, 18′ in relation to the fluid block 17 in comparison to the prior art remains unchanged in each case. During operation of the solenoid valve, the sealing lip 19, 19′ of the valve component 18, 18′ is deformed by the sealing action against the extension 16 of the valve body sleeve 15. So that this deformation has no influence or only a minimal influence on the circularity of a check valve seat 25, 25′ situated eccentrically in relation to the main valve axis, which seat cooperates with a corresponding sealing element 26, 26′, a decoupling can be performed through an intentionally provided reduction of the rigidity of the valve component 18, 18′.

As is clear from FIG. 4, the rigidity of the valve component 18′ can be reduced, for example through the provision of at least one non-solidly embodied subregion extending in the circumferential direction, which in this case is embodied for example in the form of a second annular groove 24 extending in the circumferential direction; the second annular groove 24 is depicted with dashed lines. The second annular groove 24 extending in the circumferential direction can, as needed, be stiffened in certain regions by means of radial ribs that are not shown here.

The solenoid valve according to the invention permits a rugged, homogeneous embodiment of the valve component, which comprises the lower region of the solenoid valve, making it possible for the sealing function between the valve body and the valve component to be assured with a relatively low degree of complexity. In addition, the more homogenous embodiment permits the valve component to be manufactured by means of simpler manufacturing processes using simpler molds.

1-9. (canceled)

10. A solenoid valve comprising:
a magnet assembly and a valve cartridge that includes a valve insert, a closing element movably guided inside the valve insert, and a valve body that is press-fitted into the valve insert;
a main valve has a main sealing element connected to the closing element and a main valve seat situated in the valve body; and
a magnetic force produced by the magnet assembly moves the closing element in the direction of the valve body, causing the main sealing element to travel into the main valve seat in a sealing fashion,
wherein the valve body is embodied in the form of a sleeve whose open end is press-fitted into the valve insert, the main valve seat with a through opening is situated on the inside at a cap-shaped end of the valve body sleeve, and the valve body sleeve at the cap-shaped end is embodied as elongated by means of a tubular extension so that a sealing lip of the valve component resting in a sealed fashion against the outside of the tubular extension is able to produce a seal in relation to a valve component, which comprises a bottom part of the valve.

11. The solenoid valve as recited in claim 10, wherein through a corresponding embodiment of a first annular groove situated in the valve component, the sealing lip is pressed against the tubular extension in a sealed, pressure-assisted fashion due to the pressure difference and/or the flow direction of the operating medium.

12. The solenoid valve as recited in claim 11, wherein it is possible to adjust the degree of pressure assistance by means of a length difference between a sealing region of the sealing lip against the tubular extension and a depth of the first annular groove situated in the valve component, and it is possible to use the length difference to adjust the ratio of a surface that has a seal-reinforcing action to a surface that has a seal-releasing action.

13. The solenoid valve as recited in claim 10, wherein the valve body is embodied as a metal part, preferably a steel part, and the valve component is embodied as a plastic part.

14. The solenoid valve as recited in claim 11, wherein the valve body is embodied as a metal part, preferably a steel part, and the valve component is embodied as a plastic part.

15. The solenoid valve as recited in claim 12, wherein the valve body is embodied as a metal part, preferably a steel part, and the valve component is embodied as a plastic part.

16. The solenoid valve as recited in claim 10, wherein the sealing lip of the valve component is embodied as elongated downward and, below the tubular extension, has a constriction whose diameter is predeterminable in order to set a desired throttling action.

17. The solenoid valve as recited in claim 11, wherein the sealing lip of the valve component is embodied as elongated downward and, below the tubular extension, has a constriction whose diameter is predeterminable in order to set a desired throttling action.

18. The solenoid valve as recited in claim 12, wherein the sealing lip of the valve component is embodied as elongated downward and, below the tubular extension, has a constriction whose diameter is predeterminable in order to set a desired throttling action.

19. The solenoid valve as recited in claim 15, wherein the sealing lip of the valve component is embodied as elongated downward and, below the tubular extension, has a constriction whose diameter is predeterminable in order to set a desired throttling action.

20. The solenoid valve as recited in claim 16, further comprising a check valve seat situated eccentrically in the valve component, which check valve seat is decoupled by suitable decoupling means from the sealing lip that seals against the tubular extension.

21. The solenoid valve as recited in claim 12, further comprising a check valve seat situated eccentrically in the valve component, which check valve seat is decoupled by suitable decoupling means from the sealing lip that seals against the tubular extension.

22. The solenoid valve as recited in claim 19, further comprising a check valve seat situated eccentrically in the valve component, which check valve seat is decoupled by suitable decoupling means from the sealing lip that seals against the tubular extension.

23. The solenoid valve as recited in claim 20, wherein the decoupling means is embodied by an intentionally provided reduction of a rigidity of the valve component.

24. The solenoid valve as recited in claim 21, wherein the decoupling means is embodied by an intentionally provided reduction of a rigidity of the valve component.

25. The solenoid valve as recited in claim 22, wherein the decoupling means is embodied by an intentionally provided reduction of a rigidity of the valve component.

26. The solenoid valve as recited in claim 20, wherein a rigidity of the valve component is reduced through a provision of at least one annular groove extending in a circumferential direction.

27. The solenoid valve as recited in claim 23, wherein a rigidity of the valve component is reduced through a provision of at least one annular groove extending in a circumferential direction.

28. The solenoid valve as recited in claim 11, wherein a rigidity of the valve component is reduced through a provision of at least one annular second groove extending in a circumferential direction.

29. The solenoid valve as recited in claim 26, wherein the at least one annular groove extending in the circumferential direction is stiffened in certain regions by means of radial ribs.
